(19) United States
(12) Patent Application Publication
(10) Pub. No.: US 2023/0126127 A1
(43) Pub. Date: Apr. 27, 2023

(54) FINANCIAL INFORMATION ENRICHMENT FOR INTELLIGENT CREDIT DECISION MAKING

(71) Applicant: Yodlee, Inc., San Mateo, CA (US)

(72) Inventors: Vijesh Jayaraman, Bangalore (IN); Raghavendra Shyam Mj, Bangalore (IN); Sri Harsha Jana, Bangalore (IN); Smitha Suryanarayanan, Chennai (IN); Pramod Singh, Raleigh, NC (US)

(21) Appl. No.: 17/511,426

(22) Filed: Oct. 26, 2021

(51) Int. Cl. G06Q 40/02; G06Q 40/00; G06F 16/2453

(52) U.S. Cl. CPC G06Q 40/025; G06Q 40/125; G06F 16/2453

(57) ABSTRACT

As described herein, a system, method, and computer program are provided for financial information enrichment. Individual financial transactions of consumers are identified, each individual financial transaction enhanced with at least one transaction-based categorization. Series' of the financial transactions are identified, each series' enhanced with at least one series-based categorization. The individual financial transactions are processed utilizing a first sequence of functions to enhance one or more of the individual financial transactions with at least one additional transaction-based categorization. The series' of financial transactions are processed utilizing a second sequence of functions to enhance one or more of the series' of financial transactions with at least one additional series-based categorization. Sources of income are determined for the consumers, using the individual financial transactions enhanced with the additional transaction-based categorizations and the series' of financial transactions enhanced with the additional series-based categorizations.

### FIELD OF THE INVENTION

The present invention relates to data enrichment processes.

### BACKGROUND

Lenders and underwriters in the consumer lending space increasingly find the need to leverage transactional behavioral patterns of consumers through alternate data sources for loan sanctioning. While existing software solutions are able to anonymize financial transaction data for various analysis purposes, these solutions do not provide any insights regarding the different types of income sources of users, which would be useful for credit-based decision making (e.g. lending purposes).

There is thus a need for addressing these and/or other issues associated with the prior art.

### SUMMARY

As described herein, a system, method, and computer program are provided for financial information enrichment. In use, individual financial transactions within a plurality of financial transactions associated with a plurality of consumers are identified, where the individual financial transactions are each enhanced with at least one transaction-based categorization generated therefor. Additionally, series' of financial transactions within the plurality of financial transactions are identified, where the series' of financial transactions are each enhanced with at least one series-based categorization generated therefor. Further, the individual financial transactions within the plurality of financial transactions are processed utilizing a first sequence of functions to enhance one or more of the individual financial transactions with at least one additional transaction-based categorization. Further still, the series' of financial transactions within the plurality of financial transactions are processed utilizing a second sequence of functions to enhance one or more of the series' of financial transactions with at least one additional series-based categorization. Moreover, one or more sources of income are determined for one or more consumers of the plurality of consumers, using the individual financial transactions enhanced with the at least one additional transaction-based categorization and the one or more of the series' of financial transactions enhanced with the at least one additional series-based categorization.

### BRIEF DESCRIPTION OF THE DRAWINGS

FIG. 1 illustrates a method for determining consumer sources of income from financial transactions, in accordance with one embodiment.

FIG. 2 illustrates a flow diagram of a system for determining consumer sources of income from financial transactions, in accordance with one embodiment.

FIG. 3 illustrates a method for categorizing individual financial transactions using a sequence of functions, in accordance with one embodiment.

FIG. 4 illustrates a method for categorizing series' of financial transactions using a sequence of functions, in accordance with one embodiment.

FIG. 5 illustrates a network architecture, in accordance with one possible embodiment.

FIG. 6 illustrates an exemplary system, in accordance with one embodiment.

### DETAILED DESCRIPTION

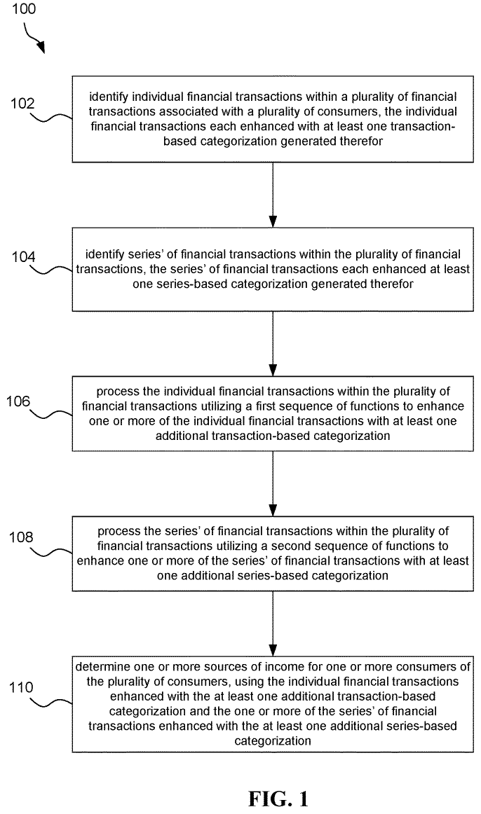

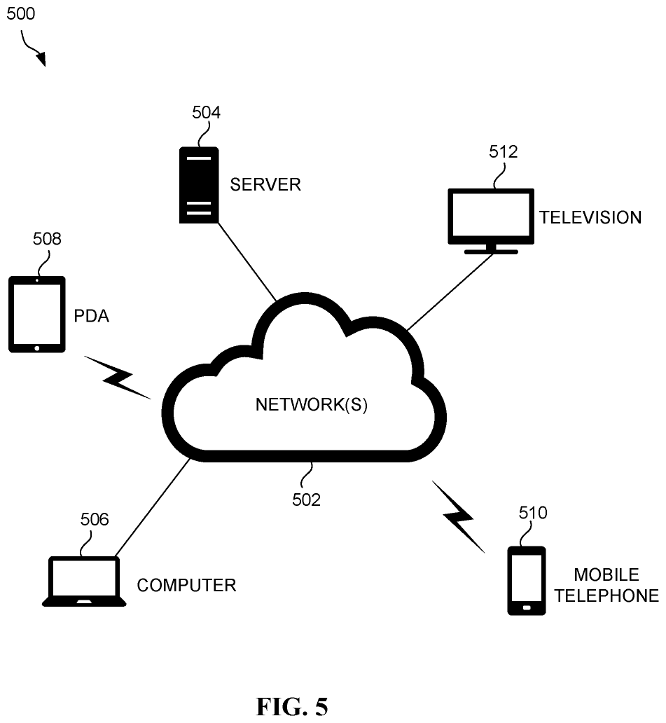

FIG. 1 illustrates a method 100 for determining consumer sources of income from financial transactions, in accordance with one embodiment. The method 100 may be performed by any computer system, such as those described below with respect to FIGS. 5 and/or 6. For example, the method 100 may be performed by a computer system interfacing a system of a financial institution that generates financial transaction data and another system independent of the financial institution that uses the financial transaction data for any analysis purposes, such as credit-related (e.g. loan-related) decision making, etc. In other embodiment, the computer system performing the method 100 may be a sub-system of the financial institution, or a sub-system of the other system performing the analysis process(es). The method 100 is performed to enrich the financial transaction data (e.g. generated by the financial institution) with consumer “source of income” data, which may thereby provide better quality financial transaction data for use by the analysis process(es).

In operation 102, individual financial transactions within a plurality of financial transactions associated with a plurality of consumers are identified, where the individual financial transactions are each enhanced with at least one transaction-based categorization generated therefor. An individual financial transaction refers to an independent recording of a financial transaction that has occurred in association with a consumer (e.g. utilizing a consumer's account with a financial institution). In one embodiment, the plurality of financial transactions may be obtained from a data structure of one or more financial institutions through which the plurality of financial transactions were performed. In another embodiment, the plurality of financial transactions may be defined in records having field values for attributes of the financial transactions (e.g. consumer identifier, date, description, amount, transaction type, etc.).

In one embodiment, the plurality of financial transactions may include only credit transactions. In another embodiment, the plurality of financial transactions may include credit transactions having one or more certain transaction-based categorizations. The transaction-based categorization(s) may indicate that the plurality of financial transactions are associated with an employer payment for a salary or other regular income. To this end, the plurality of financial transactions may be filtered from a larger set of financial transactions that also include other types, such as debit transactions, and/or other transaction-based categorization(s), such as refund-based credits.

As noted above, the individual financial transactions are each enhanced with at least one transaction-based categorization. In the context of the present description, “enhanced” refers to being included in, appended to, or otherwise correlated with, the original financial transactions. The transaction-based categorizations indicate a category of a corresponding financial transaction, such as whether the corresponding financial transaction is a credit related to a salary of a consumer associated with the corresponding financial transaction. The category may be selected from a plurality of predefined categories.

The transaction-based categorization(s) may be generated using a function (e.g. process, application, software module, etc.) that determines which predefined transaction-based categorizations apply to the attributes of the financial transactions. The function may rely on a machine learning model, in one embodiment. U.S. application Ser. No. 15/728,461, filed Oct. 9, 2017 and entitled “Hierarchical Classification of Transaction Data,” which is hereby incorporated by reference in its entirety, describes an exemplary function that may be used to provide the transaction-based categorization of the present embodiment.

In operation 104, series' of financial transactions within the plurality of financial transactions are identified, where the series' of financial transactions are each enhanced with at least one series-based categorization generated therefor. A series of financial transactions refers to two or more correlated recordings of financial transactions that have occurred in association with a consumer over a defined period of time. The financial transactions within a particular series may be correlated by virtue of having one or more certain common attributes, such as type, source of credit/transfer (e.g. bank), amount, day of the month, etc.

As noted above, the series' of financial transactions are each enhanced with at least one series-based categorization. The series-based categorizations indicate series-level information for a corresponding series of financial transactions, such as a series identifier, a periodicity of financial transactions in the corresponding series of financial transactions (e.g. Weekly, Bi-weekly, Semi-monthly, Monthly, Quarterly), and a probability of recurrence of the financial transactions in the corresponding series of financial transactions, etc.

The series-based categorization(s) may be generated using a function that determines which predefined series-based categorizations apply to the attributes of the series. The function may rely on a machine learning model, in one embodiment. U.S. application Ser. No. 15/647,184, filed Jul. 11, 2017 and entitled “Identifying Recurring Series From Transactional Data,” which is hereby incorporated by reference in its entirety, describes an exemplary function that may be used to provide the series-based categorization of the present embodiment.

In operation 106, the individual financial transactions within the plurality of financial transactions are processed utilizing a first sequence of functions to enhance one or more of the individual financial transactions with at least one additional transaction-based categorization. The functions in the first sequence are each configured to determine whether one or more additional transaction-based categorizations apply to a given one of the individual financial transactions. Each of the functions in the first sequence may be configured to make determinations about the applicability of different transaction-based categorizations to the individual financial transactions.

In one embodiment, the functions in the first sequence determine the at least one additional transaction-based categorization based on categorizations (e.g. the transaction-based categorizations) and keywords included in the one or more of the individual financial transactions. In another embodiment, each function in the first sequence may be relevant to financial transactions with certain financial transaction attributes, and in this case, once an individual financial transaction with financial transaction attributes relevant to a function in the first sequence is processed by that function, the individual financial transaction may not be processed by subsequent functions in the first sequence of functions.

Just by way of example, processing the individual financial transactions utilizing the first sequence of functions may include: (a) determining a first subset of the individual financial transactions that include information relevant to a first function in the first sequence of functions, (b) using the first function to process the first subset of the individual financial transactions relevant to the first function and passing remaining financial transactions of the individual financial transactions to a next function in the first sequence of functions, (c) determining a next subset of the remaining financial transactions that include information relevant to the next function in the first sequence of functions, (d) using the next function to process the next subset of the remaining financial transactions, and (e) repeating (c)-(d) through a last function in the first sequence of functions.

In operation 108, the series' of financial transactions within the plurality of financial transactions are processed utilizing a second sequence of functions to enhance one or more of the series' of financial transactions with at least one additional series-based categorization. The functions in the second sequence are each configured to determine whether one or more additional series-based categorizations apply to a given one of the series of financial transactions. Each of the functions in the second sequence may be configured to make determinations about the applicability of different series-based categorizations to the series of financial transactions.

In one embodiment, the functions in the second sequence determine the at least one additional series-based categorization based on categorizations (e.g. the series-based categorizations), keywords, and probability of recurrence included in the one or more of the series' of financial transactions. In another embodiment, each function in the second sequence may be relevant to series' of financial transactions with certain financial transaction attributes, and in this case once a series of financial transactions with financial transaction attributes relevant to a function in the second sequence of functions is processed by that function, the series of financial transactions may not be processed by subsequent functions in the second sequence.

Just by way of example, processing the series' of financial transactions utilizing the second sequence of functions may include: (a) determining a first subset of the series' of financial transactions that include information relevant to a first function in the second sequence of functions, (b) using the first function to process the first subset of the series' of financial transactions relevant to the first function and passing remaining series' of the series' of financial transactions to a next function in the second sequence of functions, (c) determining a next subset of the remaining series' that include information relevant to the next function in the second sequence of functions, (d) using the next function to process the next subset of the remaining series', and (e) repeating (c)-(d) through a last function in the second sequence of functions.

In operation 110, one or more sources of income are determined for one or more consumers of the plurality of consumers, using the individual financial transactions enhanced with the at least one additional transaction-based categorization and the one or more of the series' of financial transactions enhanced with the at least one additional series-based categorization. The sources of income refer to sources of the financial credits. For example, the sources of income may include one or more employers of the one or more consumers making salary payments to the one or more consumers.

As noted above, the sources of income are determined based on the enhanced individual financial transactions and the enhanced series' of financial transactions enhanced. In particular, the additional transaction-based categorization(s) and the additional series-based categorization(s) may be processed (e.g. using a machine learning model) to determine, deduce, etc. the actual or predicted sources of income for the consumers. As an option, an indication of the one or more sources of income determined for the one or more consumers may be output, for example for use in making credit-related (e.g. lending) decisions. As another option, the financial transactions may be enhanced with the indication of the one or more sources of income.

In one embodiment, flags may be created to tag inter-bank transfers (financial transfers between accounts in financial institutions for a consumer) and intra-bank transfers (financial transfers between accounts of a consumer within a same financial institution). For example, pairs of financial transactions categorized as inter-bank transfers or intra-bank transfers may be flagged. The flags may indicate probable outlier transactions within the plurality of financial transactions that are indicative of additional sources of income for one or more consumers of the plurality of consumers. Again, these sources of income may be output for use in making credit-related decisions.

More illustrative information will now be set forth regarding various optional architectures and uses in which the foregoing method may or may not be implemented, per the desires of the user. It should be strongly noted that the following information is set forth for illustrative purposes and should not be construed as limiting in any manner. Any of the following features may be optionally incorporated with or without the exclusion of other features described.

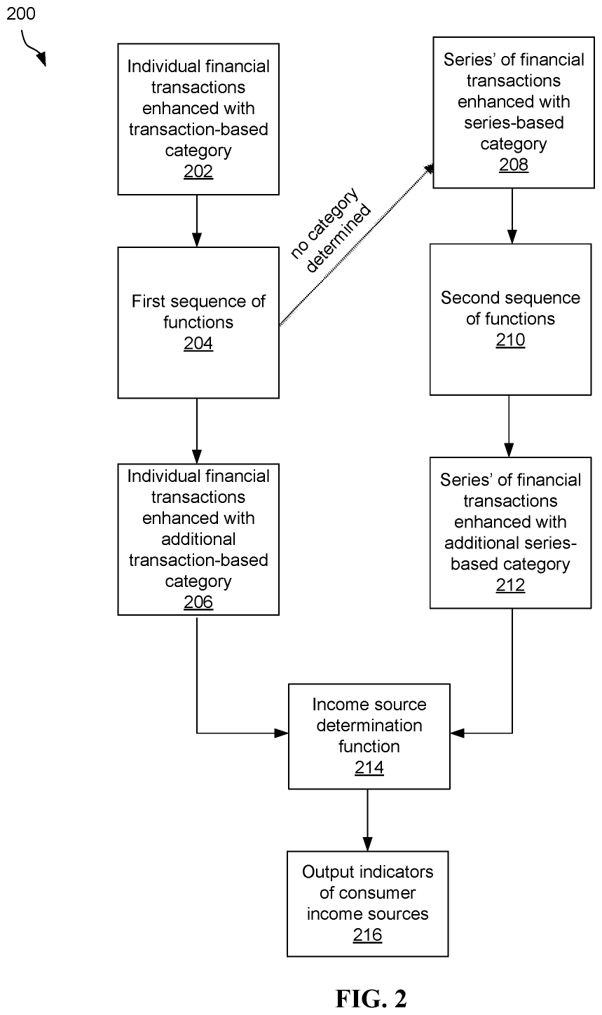

FIG. 2 illustrates a flow diagram of a system 200 for determining consumer sources of income from financial transactions, in accordance with one embodiment. As an option, the system 200 may be implemented in the context of the details of the previous figure and/or any subsequent figure(s). Of course, however, the system 200 may be implemented in the context of any desired environment. Further, the aforementioned definitions may equally apply to the description below.

As shown, individual financial transactions 202 (that have each been enhanced with at least one transaction-based categorization and that are associated with consumers) are input to a first sequence of functions 204. The functions in the first sequence 204 may be ordered in any desired manner, such as based on a weighted, pre-determined hierarchy. The individual financial transactions 202 are processed utilizing the first sequence of functions 204 to generate output that includes the individual financial transactions enhanced with at least one additional transaction-based categorization 206. Any individual transactions that are not enhanced with at least one additional categorization are output to 208 described below.

In addition, series' of the financial transactions 208 (that have each been enhanced with at least one series-based categorization) are input to a second sequence of functions 210. The functions in the second sequence 210 may be ordered in any desired manner, such as based on a weighted, pre-determined hierarchy. The series' of financial transactions 208 are processed utilizing the second sequence of functions 210 to generate output that includes the series' of financial transactions enhanced with at least one additional series-based categorization 212.

Further, the individual financial transactions enhanced with at least one additional transaction-based categorization 206 along with the series' of financial transactions enhanced with at least one additional series-based categorization 212 are input to an income source determination function 214. The income source determination function 214 processes the input to determine one or more income sources for the consumers. The income source determination function 214 generates output that includes indicators of income sources determined the users.

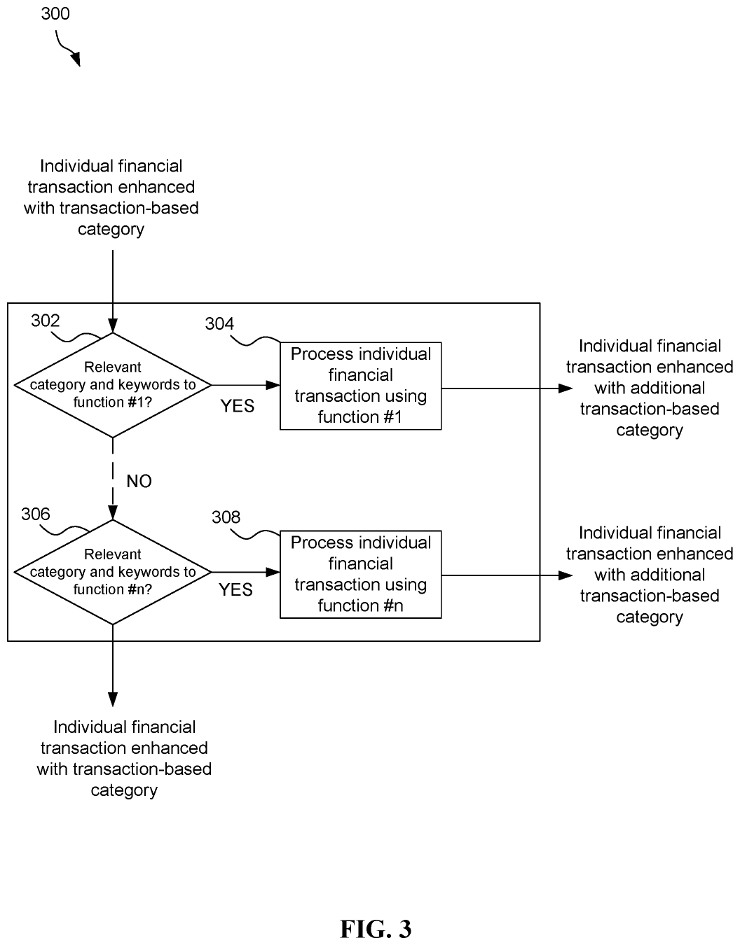

FIG. 3 illustrates a method 300 for categorizing individual financial transactions using a sequence of functions, in accordance with one embodiment. As an option, the method 300 may be carried out in the context of the details of the previous figure and/or any subsequent figure(s). For example, the method 300 may be carried out by the first sequence of functions 204 of FIG. 2. Of course, however, the method 300 may be carried out in the context of any desired environment. Further, the aforementioned definitions may equally apply to the description below.

As shown, an individual financial transaction (already enhanced with at least one transaction-based categorization) is input to a sequence of functions (e.g. first sequence of functions 204 of FIG. 2). Each function in the sequence is relevant to (e.g. corresponds to) different financial transaction attributes, including different combinations of categories and keywords.

Initially, it is determined in decision 302 whether the individual financial transaction is relevant to the category and keywords corresponding to the first listed function in the sequence of functions. If it is determined in decision 302 that the individual financial transaction is relevant to the category and keywords corresponding to the first listed function, then the first listed function is utilized to process the individual financial transaction and to enhance the individual financial transaction with at least one additional transaction-based categorization, as shown in operation 304.

If it is determined in decision 302 that the individual financial transaction is not relevant to the category and keywords corresponding to the first listed function, then relevancy to the category and keywords corresponding to the next listed function in the sequence is checked. This step repeats for each function in the sequence through a last function in the sequence (see decision 306), or until a relevant function in the sequence is identified, whichever occurs first. A first function in the sequence that is found to be relevant to the individual financial transaction is utilized to process the individual financial transaction for enhancement thereof with at least one additional transaction-based categorization, including when the first function found to be relevant is the last listed function in the sequence (see operation 308). If no function in the sequence is relevant to the individual financial transaction, then the individual financial transaction is output without the additional enhancement.

This method 300 therefore operates such that transactions processed utilizing a particular function in the sequence are not carried over to subsequent functions. As a result, vital categorization information for each individual financial transaction may be preserved and unnecessary overwriting may be prevented.

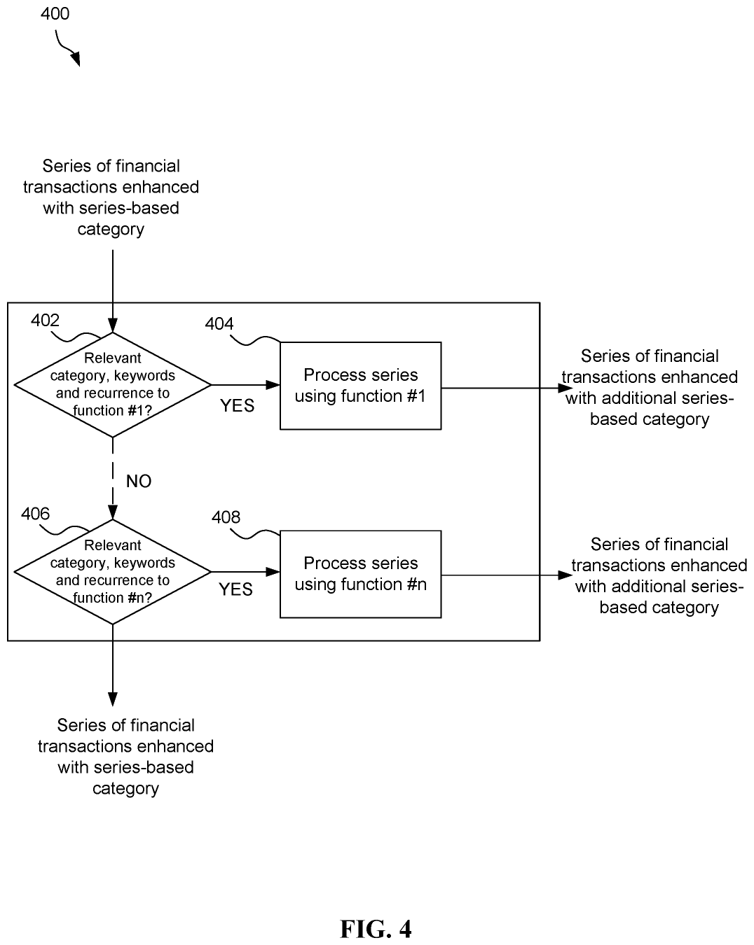

FIG. 4 illustrates a method 400 for categorizing series' of financial transactions using a sequence of functions, in accordance with one embodiment. As an option, the method 300 may be carried out in the context of the details of the previous figure and/or any subsequent figure(s). For example, the method 400 may be carried out by the second sequence of functions 210 of FIG. 2. Of course, however, the method 400 may be carried out in the context of any desired environment. Further, the aforementioned definitions may equally apply to the description below.

As shown, a series of financial transactions (already enhanced with at least one series-based categorization) is input to a sequence of functions (e.g. second sequence of functions 210 of FIG. 2). Each function in the sequence is relevant to (e.g. corresponds to) different series attributes, including different combinations of categories, keywords, and recurrence probabilities.

Initially, it is determined in decision 402 whether the series is relevant to the category, keywords, and recurrence probability corresponding to the first listed function in the sequence of functions. If it is determined in decision 402 that the series is relevant to the category, keywords, and recurrence probability corresponding to the first listed function, then the first listed function is utilized to process the series and to enhance the financial transactions included in the series with at least one additional series-based categorization, as shown in operation 404.

If it is determined in decision 402 that the series is not relevant to the category, keywords, and recurrence probability corresponding to the first listed function, then relevancy to the category, keywords, and recurrence probability corresponding to the next listed function in the sequence is checked. This step repeats for each function in the sequence through a last function in the sequence (see decision 406), or until a relevant function in the sequence is identified, whichever occurs first. A first function in the sequence that is found to be relevant to the series is utilized to process the series for enhancement thereof with at least one additional series-based categorization, including when the first function found to be relevant is the last listed function in the sequence (see operation 408). If no function in the sequence is relevant to the series, then the series is output without the additional enhancement.

Similar to the method 300 of FIG. 3, this method 400 operates such that series processed utilizing a particular function in the sequence are not carried over to subsequent functions. As a result, vital categorization information for each financial transaction in a series may be preserved and unnecessary overwriting may be prevented.

FIG. 5 illustrates a network architecture 500, in accordance with one possible embodiment. As shown, at least one network 502 is provided. In the context of the present network architecture 500, the network 502 may take any form including, but not limited to a telecommunications network, a local area network (LAN), a wireless network, a wide area network (WAN) such as the Internet, peer-to-peer network, cable network, etc. While only one network is shown, it should be understood that two or more similar or different networks 502 may be provided.

Coupled to the network 502 is a plurality of devices. For example, a server computer 504 and an end user computer 506 may be coupled to the network 502 for communication purposes. Such end user computer 506 may include a desktop computer, lap-top computer, and/or any other type of logic. Still yet, various other devices may be coupled to the network 502 including a personal digital assistant (PDA) device 508, a mobile phone device 510, a television 512, etc.

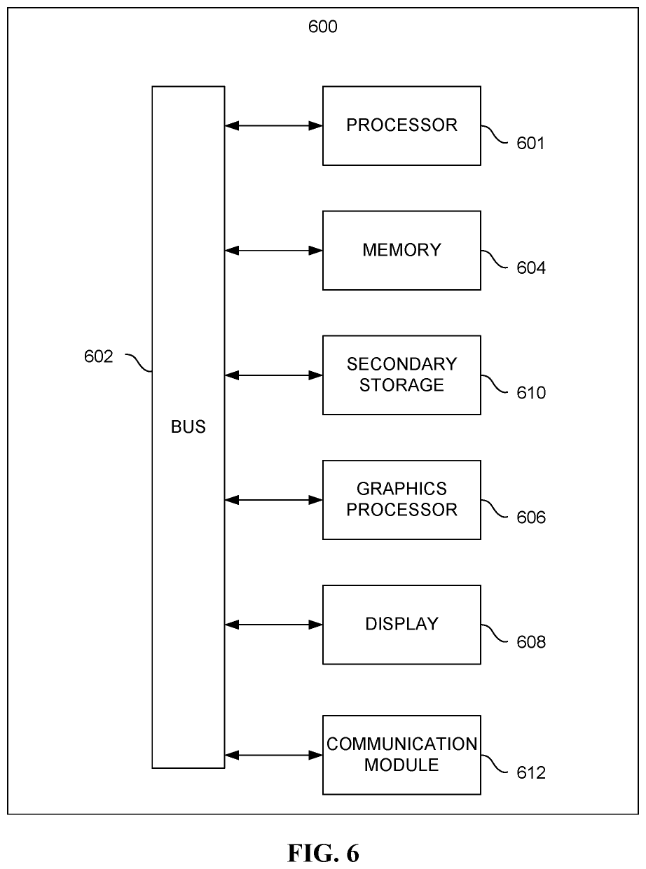

FIG. 6 illustrates an exemplary system 600, in accordance with one embodiment. As an option, the system 600 may be implemented in the context of any of the devices of the network architecture 500 of FIG. 5. Of course, the system 600 may be implemented in any desired environment.

As shown, a system 600 is provided including at least one central processor 601 which is connected to a communication bus 602. The system 600 also includes main memory 604 [e.g. random access memory (RAM), etc.]. The system 600 also includes a graphics processor 606 and a display 608.

The system 600 may also include a secondary storage 610. The secondary storage 610 includes, for example, solid state drive (SSD), flash memory, a removable storage drive, etc. The removable storage drive reads from and/or writes to a removable storage unit in a well-known manner.

Computer programs, or computer control logic algorithms, may be stored in the main memory 604, the secondary storage 610, and/or any other memory, for that matter. Such computer programs, when executed, enable the system 600 to perform various functions (as set forth above, for example). Memory 604, storage 610 and/or any other storage are possible examples of non-transitory computer-readable media.

The system 600 may also include one or more communication modules 612. The communication module 612 may be operable to facilitate communication between the system 600 and one or more networks, and/or with one or more devices through a variety of possible standard or proprietary communication protocols (e.g. via Bluetooth, Near Field Communication (NFC), Cellular communication, etc.).

As used here, a “computer-readable medium” includes one or more of any suitable media for storing the executable instructions of a computer program such that the instruction execution machine, system, apparatus, or device may read (or fetch) the instructions from the computer readable medium and execute the instructions for carrying out the described methods. Suitable storage formats include one or more of an electronic, magnetic, optical, and electromagnetic format. A non-exhaustive list of conventional exemplary computer readable medium includes: a portable computer diskette; a RAM; a ROM; an erasable programmable read only memory (EPROM or flash memory); optical storage devices, including a portable compact disc (CD), a portable digital video disc (DVD), a high definition DVD (HD-DVD™), a BLU-RAY disc; and the like.

It should be understood that the arrangement of components illustrated in the Figures described are exemplary and that other arrangements are possible. It should also be understood that the various system components (and means) defined by the claims, described below, and illustrated in the various block diagrams represent logical components in some systems configured according to the subject matter disclosed herein.

For example, one or more of these system components (and means) may be realized, in whole or in part, by at least some of the components illustrated in the arrangements illustrated in the described Figures. In addition, while at least one of these components are implemented at least partially as an electronic hardware component, and therefore constitutes a machine, the other components may be implemented in software that when included in an execution environment constitutes a machine, hardware, or a combination of software and hardware.

More particularly, at least one component defined by the claims is implemented at least partially as an electronic hardware component, such as an instruction execution machine (e.g., a processor-based or processor-containing machine) and/or as specialized circuits or circuitry (e.g., discreet logic gates interconnected to perform a specialized function). Other components may be implemented in software, hardware, or a combination of software and hardware. Moreover, some or all of these other components may be combined, some may be omitted altogether, and additional components may be added while still achieving the functionality described herein. Thus, the subject matter described herein may be embodied in many different variations, and all such variations are contemplated to be within the scope of what is claimed.

In the description above, the subject matter is described with reference to acts and symbolic representations of operations that are performed by one or more devices, unless indicated otherwise. As such, it will be understood that such acts and operations, which are at times referred to as being computer-executed, include the manipulation by the processor of data in a structured form. This manipulation transforms the data or maintains it at locations in the memory system of the computer, which reconfigures or otherwise alters the operation of the device in a manner well understood by those skilled in the art. The data is maintained at physical locations of the memory as data structures that have particular properties defined by the format of the data. However, while the subject matter is being described in the foregoing context, it is not meant to be limiting as those of skill in the art will appreciate that several of the acts and operations described hereinafter may also be implemented in hardware.

To facilitate an understanding of the subject matter described herein, many aspects are described in terms of sequences of actions. At least one of these aspects defined by the claims is performed by an electronic hardware component. For example, it will be recognized that the various actions may be performed by specialized circuits or circuitry, by program instructions being executed by one or more processors, or by a combination of both. The description herein of any sequence of actions is not intended to imply that the specific order described for performing that sequence must be followed. All methods described herein may be performed in any suitable order unless otherwise indicated herein or otherwise clearly contradicted by context.

The use of the terms “a” and “an” and “the” and similar referents in the context of describing the subject matter (particularly in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. Furthermore, the foregoing description is for the purpose of illustration only, and not for the purpose of limitation, as the scope of protection sought is defined by the claims as set forth hereinafter together with any equivalents thereof entitled to. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

The embodiments described herein included the one or more modes known to the inventor for carrying out the claimed subject matter. Of course, variations of those embodiments will become apparent to those of ordinary skill in the art upon reading the foregoing description. The inventor expects skilled artisans to employ such variations as appropriate, and the inventor intends for the claimed subject matter to be practiced otherwise than as specifically described herein. Accordingly, this claimed subject matter includes all modifications and equivalents of the subject matter recited in the claims appended hereto as permitted by applicable law. Moreover, any combination of the above-described elements in all possible variations thereof is encompassed unless otherwise indicated herein or otherwise clearly contradicted by context.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A non-transitory computer-readable media storing computer instructions which when executed by one or more processors of a device cause the device to:
identify individual financial transactions within a plurality of financial transactions associated with a plurality of consumers, the individual financial transactions each enhanced with at least one transaction-based categorization generated therefor;
identify series' of financial transactions within the plurality of financial transactions, the series' of financial transactions each enhanced with at least one series-based categorization generated therefor;
process the individual financial transactions within the plurality of financial transactions utilizing a first sequence of functions to enhance one or more of the individual financial transactions with at least one additional transaction-based categorization;
process the series' of financial transactions within the plurality of financial transactions utilizing a second sequence of functions to enhance one or more of the series' of financial transactions with at least one additional series-based categorization;
determine one or more sources of income for one or more consumers of the plurality of consumers, using the individual financial transactions enhanced with the at least one additional transaction-based categorization and the one or more of the series' of financial transactions enhanced with the at least one additional series-based categorization.

2. The non-transitory computer-readable media of claim 1, wherein the plurality of financial transactions are obtained from a data structure of one or more financial institutions through which the plurality of financial transactions were performed.

3. The non-transitory computer-readable media of claim 1, wherein the plurality of financial transactions are defined in records having field values for attributes of the financial transactions, and wherein the records are enhanced to include the transaction-based categorizations, the series-based categorizations, the additional transaction-based categorizations and the additional series-based categorizations.

4. The non-transitory computer-readable media of claim 1, wherein the transaction-based categorizations indicate a category of a corresponding financial transaction.

5. The non-transitory computer-readable media of claim 4, wherein the category indicates whether the corresponding financial transaction is a credit related to a salary of a consumer associated with the corresponding financial transaction.

6. The non-transitory computer-readable media of claim 1, wherein the series-based categorizations indicate series-level information for a corresponding series of financial transactions.

7. The non-transitory computer-readable media of claim 6, wherein the series-level information includes a series identifier, a periodicity of financial transactions in the corresponding series of financial transactions, and a probability of recurrence of the financial transactions in the corresponding series of financial transactions.

8. The non-transitory computer-readable media of claim 1, wherein functions in the first sequence of functions determine the at least one additional transaction-based categorization based on categorizations and keywords included in the one or more of the individual financial transactions.

9. The non-transitory computer-readable media of claim 1, wherein functions in the second sequence of functions determine the at least one additional series-based categorization based on categorizations, keywords, and probability of recurrence included in the one or more of the series' of financial transactions.

10. The non-transitory computer-readable media of claim 1, wherein each function in the first sequence of functions is relevant to financial transactions with certain financial transaction attributes, and wherein once an individual financial transaction with financial transaction attributes relevant to a function in the first sequence of functions is processed by the function, the individual financial transaction is not processed by subsequent functions in the first sequence of functions.

11. The non-transitory computer-readable media of claim 1, wherein processing the individual financial transactions utilizing the first sequence of functions includes:
(a) determining a first subset of the individual financial transactions that include information relevant to a first function in the first sequence of functions,
(b) using the first function to process the first subset of the individual financial transactions relevant to the first function and passing remaining financial transactions of the individual financial transactions to a next function in the first sequence of functions,
(c) determining a next subset of the remaining financial transactions that include information relevant to the next function in the first sequence of functions,
(d) using the next function to process the next subset of the remaining financial transactions, and
(e) repeating (c)-(d) through a last function in the first sequence of functions.

12. The non-transitory computer-readable media of claim 1, wherein each function in the second sequence of functions is relevant to series' of financial transactions with certain financial transaction attributes, and wherein once a series of financial transactions with financial transaction attributes relevant to a function in the second sequence of functions is processed by the function, the series of financial transactions is not processed by subsequent functions in the second sequence of functions.

13. The non-transitory computer-readable media of claim 1, processing the series' of financial transactions utilizing the second sequence of functions includes:
(a) determining a first subset of the series' of financial transactions that include information relevant to a first function in the second sequence of functions,
(b) using the first function to process the first subset of the series' of financial transactions relevant to the first function and passing remaining series' of the series' of financial transactions to a next function in the second sequence of functions,
(c) determining a next subset of the remaining series' that include information relevant to the next function in the second sequence of functions,
(d) using the next function to process the next subset of the remaining series', and
(e) repeating (c)-(d) through a last function in the second sequence of functions.

14. The non-transitory computer-readable media of claim 1, wherein the one or more sources of income include one or more employers of the one or more consumers making salary payments to the one or more consumers.

15. The non-transitory computer-readable media of claim 1, further comprising creating flags to tag inter-bank transfers and intra-bank transfers.

16. The non-transitory computer-readable media of claim 15, wherein the flags indicate probable outlier transactions within the plurality of financial transactions that are indicative of additional sources of income for one or more consumers of the plurality of consumers.

17. The non-transitory computer-readable media of claim 1, further comprising;
outputting an indication of the one or more sources of income determined for the one or more consumers.

18. The non-transitory computer-readable media of claim 17, wherein the indication of the one or more sources of income determined for the one or more consumers is output for use in making credit-related decisions.

19. A method, comprising:
at a computer system:
identifying individual financial transactions within a plurality of financial transactions associated with a plurality of consumers, the individual financial transactions each enhanced with at least one transaction-based categorization generated therefor;
identifying series' of financial transactions within the plurality of financial transactions, the series' of financial transactions each enhanced with at least one series-based categorization generated therefor;
processing the individual financial transactions within the plurality of financial transactions utilizing a first sequence of functions to enhance one or more of the individual financial transactions with at least one additional transaction-based categorization;
processing the series' of financial transactions within the plurality of financial transactions utilizing a second sequence of functions to enhance one or more of the series' of financial transactions with at least one additional series-based categorization;
determining one or more sources of income for one or more consumers of the plurality of consumers, using the individual financial transactions enhanced with the at least one additional transaction-based categorization and the one or more of the series' of financial transactions enhanced with the at least one additional series-based categorization.

20. A system, comprising:
a non-transitory memory storing instructions; and
one or more processors in communication with the non-transitory memory that execute the instructions to:
identify individual financial transactions within a plurality of financial transactions associated with a plurality of consumers, the individual financial transactions each enhanced with at least one transaction-based categorization generated therefor;
identify series' of financial transactions within the plurality of financial transactions, the series' of financial transactions each enhanced with at least one series-based categorization generated therefor;
process the individual financial transactions within the plurality of financial transactions utilizing a first sequence of functions to enhance one or more of the individual financial transactions with at least one additional transaction-based categorization;
process the series' of financial transactions within the plurality of financial transactions utilizing a second sequence of functions to enhance one or more of the series' of financial transactions with at least one additional series-based categorization;
determine one or more sources of income for one or more consumers of the plurality of consumers, using the individual financial transactions enhanced with the at least one additional transaction-based categorization and the one or more of the series' of financial transactions enhanced with the at least one additional series-based categorization.
